(19) United States
(12) Patent Application Publication
(10) Pub. No.: US 2011/0062106 A1
(43) Pub. Date: Mar. 17, 2011

(54) Closure for a Bottle, and Assembly of Such a Closure and a Bottle

(75) Inventor: Wessel Anton Caspar Akveld, Amsterdam (NL)

(73) Assignee: 4SIGHT INNOVATION B.V., Alkmaar (NL)

(21) Appl. No.: 12/675,627

(22) PCT Filed: Aug. 29, 2008
(86) PCT No.: PCT/NL2008/050576

§ 371 Date: Jun. 28, 2010

(30) Foreign Application Priority Data
Aug. 29, 2007 (NL) 2000838

(51) Int. Cl. B65D 1/02; B65D 55/02; B23P 17/00

(52) U.S. Cl. 215/40; 215/201; 29/525.01

(57) ABSTRACT

The invention relates to a closure for a bottle. The inventor also relates to an assembly of a closure according to the invention and a bottle. The invention further relates to a method for assembling an assembly of a closure according to the invention and a bottle.

The invention relates to a closure for a bottle. The invention also relates to an assembly of such a closure and a bottle. The invention further relates to a method for assembling such an assembly.

Already known since 1891 are closures particularly for making possible medium-tight closure of a drink container for the purpose of enabling durable conservation of drink stored in the drink container, usually in bottles. The cap can be removed from the bottle by means of a bottle-opener or other suitable tool, after which the drink can be consumed. The drawback of the conventional closure is that removal of the closure is generally only possible by making use of a separate tool, such as a bottle-opener, suitable for the purpose.

The American U.S. Pat. No. 6,158,604 describes an improved closure for a bottle manufactured from plastic, comprising a closing element provided with a number of clamping elements adapted to engage on an outer side of the neck of the bottle. The closing element is here also provided with an external screw thread. The known closure also comprises a securing element arranged on the closing element to enable selective securing and release of the clamping elements. The securing element is provided for this purpose with an internal screw thread adapted for co-action with the external screw thread of the closing element. The orientation of the securing element relative to the closing element can be changed by rotating the securing element axially relative to the closing element, whereby the securing element can secure or release the clamping elements to enable respectively closing or opening of the bottle. Although the known closure can be removed from a bottle relatively easily by a consumer without making use of separate tools, the known closure also has a number of drawbacks. A significant drawback of the known closure is that the construction of the closure is relatively bulky, and therefore robust. Research has shown here that the relatively bulky closure arouses consumer aversion, and is therefore not accepted, or hardly so.

The invention has for its object to provide a relatively compact closure for a bottle.

The invention provides for this purpose a closure of the type stated in the preamble, comprising: a closing element provided with a number of clamping elements adapted to engage on a neck of a bottle, this closing element also being provided with coupling means, and a securing element connected to the closing element and provided with locking means for the clamping elements, this securing element also being provided with counter-coupling means adapted for co-action with the coupling means for the purpose of connecting the closing element to the securing element, wherein the coupling means and counter-coupling means are adapted to be substantially received in the neck of the bottle, and wherein the coupling means and counter-coupling means are adapted to limit the relative displacement of the securing element relative to the closing element, and wherein the orientation between the closing element and the securing element can be changed between a released position, in which the locking means leave the clamping means substantially unobstructed, and a secured position, in which the locking means substantially lock and thereby substantially fix the clamping means. When the closure according to the invention is arranged on a neck of a bottle, the coupling means will generally be located substantially in the neck of the bottle in both the secured and the released position, while the counter-coupling means are generally located substantially in the neck of the bottle in the secured position and at least partially outside the neck of the bottle in the released position. By in fact realizing the coupling between the closing element and the securing element substantially in the neck of the bottle instead of outside the neck of the bottle, the volume occupied by the closure according to the invention can be reduced substantially relative to the volume occupied by the known closure. A material-saving can also be realized due to the relatively efficient construction of the closure according to the invention, this being favourable from an economic viewpoint. The relatively compact, slender design of the closure according to the invention will moreover be more readily accepted by consumers. Another significant advantage of the closure according to the invention is that the closure can close a bottle in relatively reliable manner. The closure known from the prior art has the drawback that the coupling means and the counter-coupling means formed by the threaded connection are situated outside the bottle. If the temperature increases, the closure manufactured from plastic will expand relative to the bottle, whereby the bottle can no longer be closed in reliable manner. By positioning the coupling means and counter-coupling means of the closure according to the invention substantially in the neck of the bottle in at least the secured position, the coupling means and the counter-coupling means will expand less strongly in the case of fluctuations in the temperature in the atmosphere surrounding the bottle since the coupling means and the counter-coupling means are positioned within an environment which is insulated to some extent by the bottle. If the temperature in the bottle increases, the coupling means and the counter-coupling means will moreover be able to expand possibly as far as an inner side of the neck of the bottle and thereby possibly engage more closely on the inner side of the neck of the bottle, thereby guaranteeing a reliable closure of the bottle. Similarly to the known closure, the closure according to the invention can be operated in relatively simple manner by a consumer without a separate tool here being required. It is noted that bottle must be interpreted relatively broadly in the context of this patent, wherein any other container, in particular foodstuff container, more particularly drink container, provided with a neck of any form whatever is also deemed to be a bottle in the present situation. The bottle will however generally be formed by a conventional drink bottle made of glass and/or plastic, this drink bottle comprising a body and a narrower neck connected to the body. A further significant advantage of the closure according to the invention is that the coupling means and the counter-coupling means are adapted to limit the displacement of the securing element relative to the closing element (and vice versa), whereby unintentional release of the securing element relative to the closing element can be prevented. In this way the securing element will thus remain connected non-releasably to the closing element. The limiting of the relative displacement of the closing element and the securing element can relate to an axial displacement and/or to a rotating displacement of the securing element relative to the closing element. The limiting of the maximal displacement of the securing element relative to the closing element can be realized in diverse ways, wherein one or more stops are usually applied. Diverse preferred embodiments for limiting the securing element relative to the closing element will be described hereinbelow.

The closing element will generally function as inner cap and the securing element will function as an outer cap co-acting with the inner cap. By displacing and preferably (axially) rotating the outer cap relative to the inner cap the closure can be brought into the secured position or into the released position. The coupling means and the counter-coupling means are more preferably formed here by a threaded connection, wherein the coupling means comprise a screw thread and the counter-coupling means comprise a counter-screw thread. A threaded connection is relatively strong and durable, whereby the closure can be brought into and held in relatively reliable manner in the secured position or released position. It will be apparent that another type of connection, such as for instance a bayonet coupling (bayonet fitting) or a snap connection, can also be used in addition to a threaded connection. Both the threaded connection and the bayonet coupling, as well as the snap connection, are or at least can be adapted to limit the maximum displacement of the securing element relative to the closing element in order to prevent undesired removal of the closure according to the invention. In general the securing element will ultimately be displaceable with a substantially linear movement relative to the closing element in order to allow relatively efficient engagement of the locking means on the clamping elements in the secured position and to allow positioning of the locking means substantially at a distance from the clamping elements in the released position.

In a preferred embodiment the closing element comprises a tubular element provided with the coupling means, this tubular element being adapted to receive a part of the securing element provided with the counter-coupling means. When the closure is arranged on a bottle, the tubular element is positioned in the secured position at least partially, and preferably substantially in the neck of the bottle. The tubular element will generally be given a substantially cylindrical form and will generally be opened on one side (on a top side directed toward the securing element) in order to thus provide access to at least a part of the counter-coupling means. An inward directed side of the tubular element is preferably provided here with the coupling means. The counter-coupling means are preferably arranged on a protruding bush-like, more preferably cylindrical body forming part of the securing element, wherein the tubular element is more preferably adapted to receive at least a part of the bush-like body. An external side of the bush-like body is here preferably provided with the counter-coupling means. The bush-like body is more preferably adapted to receive at least one standing blocking element connected to the tubular element, which blocking element is provided with at least one first protrusion for limiting the relative movement of the securing element relative to the closing element. The securing element can be connected non-releasably to the closing element by limiting the relative displacement of the securing element relative to the closing element. The closure hereby remains permanently in the assembled position, whereby unintentional removal of the securing element from the closing element can be prevented. In order to limit the relative displacement of the securing element relative to the closing element in more reliable manner, it is advantageous that the bush-like body be provided with at least one second protrusion, wherein the first protrusion forms a stop for the second protrusion. When the closure is arranged on a bottle and the closure is situated in the released position, the closure as such can be removed from the bottle by pulling on the securing element in a direction away from the bottle, whereby both the securing element and the closing element connected (permanently) to the securing element can be removed from the bottle. The closing element and/or the securing element will generally be provided with at least one gripping member for a user. The gripping member can for instance be formed by a pull tab, but also by a profiling arranged on the closing element and/or on the securing element.

Since an (initial) underpressure or an overpressure may be present in the bottle, the closing element preferably comprises at least one ventilation opening. By means of applying one or more ventilation openings a pressure equalization can be realized by venting or bleeding between the pressure in the bottle and the pressure outside the bottle, after which the closure can be removed from the bottle with relatively little resistance. The securing element is more preferably adapted to close the ventilation opening in the secured position of the closure. The ventilation opening can be opened by displacing the securing element relative to the closing element in the direction of the released position, and venting or bleeding can take place. An alternative ventilation opening could be formed by a gap which is formed between the closing element and the neck of the bottle and which can be formed during displacement of the securing element relative to the closing element from the secured position (to the released position). The securing element can optionally close the ventilation opening in the secured position via a sealing element, whereby the ventilation opening can be closed in more reliable and durable manner.

In another preferred embodiment the closure comprises a breakable or otherwise removable seal connected to the closing element and/or the securing element, usually referred to as a tamper-evident provision, for the purpose of guaranteeing the content of the bottle for a consumer. During initial opening of the foodstuff container the seal will be discernibly, in particular visibly, and generally irreparably damaged by a consumer. The seal can be realized in different ways. It is for instance possible here to envisage the seal forming a breakable connection between the securing element and the closing element. It is however also possible for instance to envisage the seal forming a connection between the securing element and the bottle.

In order to be able to realize a substantially medium-tight closure of the bottle, it is advantageous that the closure comprises sealing means. The sealing means will here generally be manufactured from an elastic material, in particular an elastomer. The sealing means are generally adapted to allow the closing element to engage on the neck of a bottle via the sealing means, in particular a peripheral side of the neck of the bottle. In a particular preferred embodiment at least a part of the sealing means is adapted to engage on an inner side of the neck of the bottle in order to enable optimizing of the seal.

The clamping elements are preferably adapted for deformation during securing and/or release of the closure. The clamping elements are preferably manufactured for this purpose from an elastic material. It is also possible to envisage each clamping element being given a (to some extent) pivotable form, for instance by applying one or more weakening lines. Such a preferred embodiment makes use of the deforming capability of the clamping elements and provides for a rapid and efficient closing of the bottle. In a particular preferred embodiment the clamping elements comprise resilient clamping tongues arranged substantially in the peripheral direction of the closing element. A segmented (clamping) skirt is in fact created by positioning the clamping elements in the peripheral direction of the closing element. The clamping elements, and particularly the clamping tongues, can be adapted here to engage on a peripheral recess of the neck of the drink container. A durable and operationally reliable closure of the bottle can hereby be realized.

The closure according to the invention is preferably manufactured at least partially from at least one material chosen from the group of metals, metal alloys and plastics. Metal, in particular aluminium, and determined plastics are generally particularly suitable for use as closure to enable substantially medium tight closure of a bottle in relatively durable manner. A particularly suitable variant is obtained when the closing element is manufactured from an at least partially transparent plastic; and the securing element from a differently coloured plastic. The components from which the closure is constructed hereby become clearly apparent to a consumer. When the securing element is provided with a viewing opening, the content of the bottle moreover becomes visible via the applied transparent closing element.

The invention also relates to a closing element for use in the closure according to the invention. The invention further relates to a securing element for use in the closure according to the invention. It is possible to envisage both the closing element and the securing element being marketed separately. Advantages and preferred embodiments of the closing element and the securing element have already been described at length in the foregoing.

The invention also relates to an assembly of a bottle and a closure according to the invention connected to the bottle, wherein at least the coupling means are positioned substantially in a neck forming part of the bottle. The counter-coupling means are positioned substantially in the neck of the bottle in the secured position. The counter-coupling means will moreover be positioned at least partially outside the neck of the bottle in the released position in order to allow facilitated release of the clamping elements. The clamping elements here preferably engage on a peripheral side, and in particular outer side, of the neck of the bottle.

The invention furthermore relates to a method for assembling the assembly according to the invention, comprising the steps of: A) filling the bottle with a product, in particular a drink, B) arranging the closing element on a neck forming part of the bottle, and C) connecting the securing element to the closing element. In an alternative preferred embodiment step C) is performed before step B), whereby the closure according to the invention is first assembled before being arranged on the neck of the bottle. The method will usually also comprise step D), wherein step D) relates to cleaning of the assembly of the bottle and at least a part of the closure. The cleaning can take place here using a rinsing liquid, preferably water. The cleaning can take place after placing of only the closing element (step B) or after placing of the already assembled closure (step C).

The invention will be elucidated on the basis of non-limitative exemplary embodiments shown in the following figures. Herein:

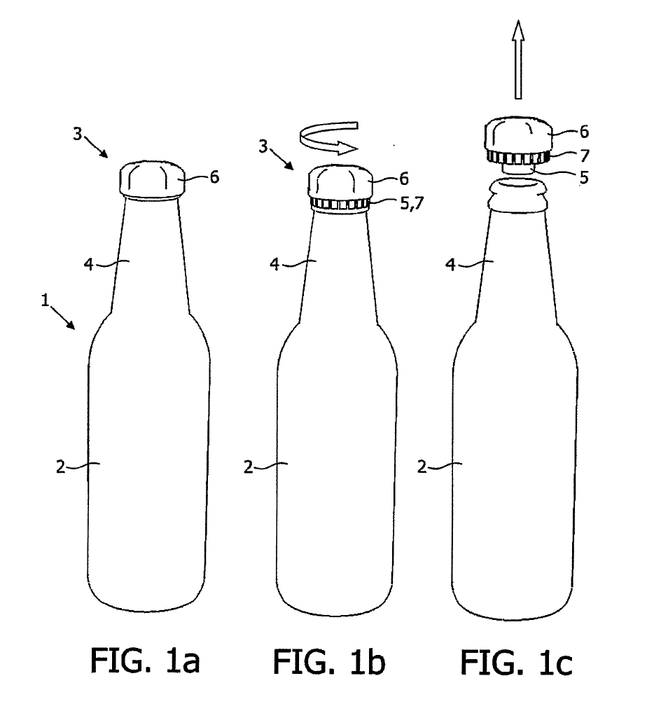

FIGS. 1a-1c show side views of an assembly of a bottle and a closure according to the invention,

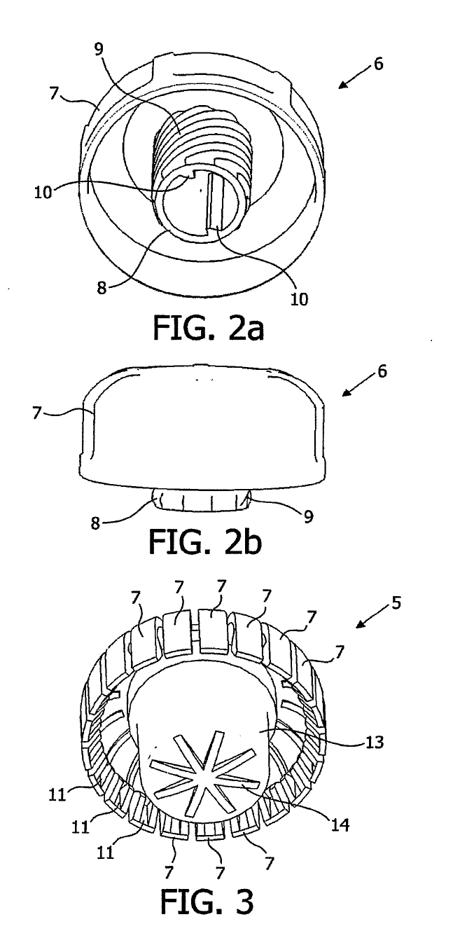

FIGS. 2a and 2b show different views of a securing element for use in the closure according to FIGS. 1a-1c,

FIG. 3 is a perspective view of a closing element for use in the closure according to FIGS. 1a-1c,

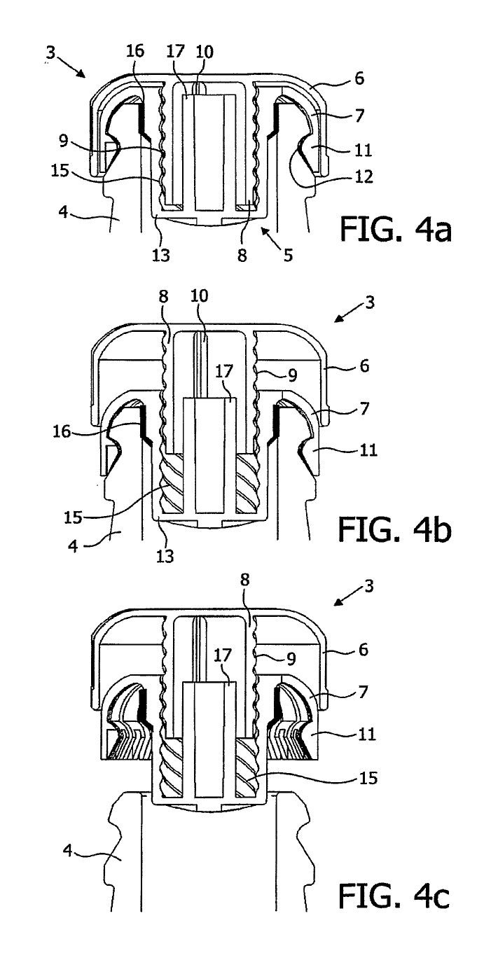

FIGS. 4a-4c show longitudinal sections of a part of the assembly according to FIGS. 1a-1c,

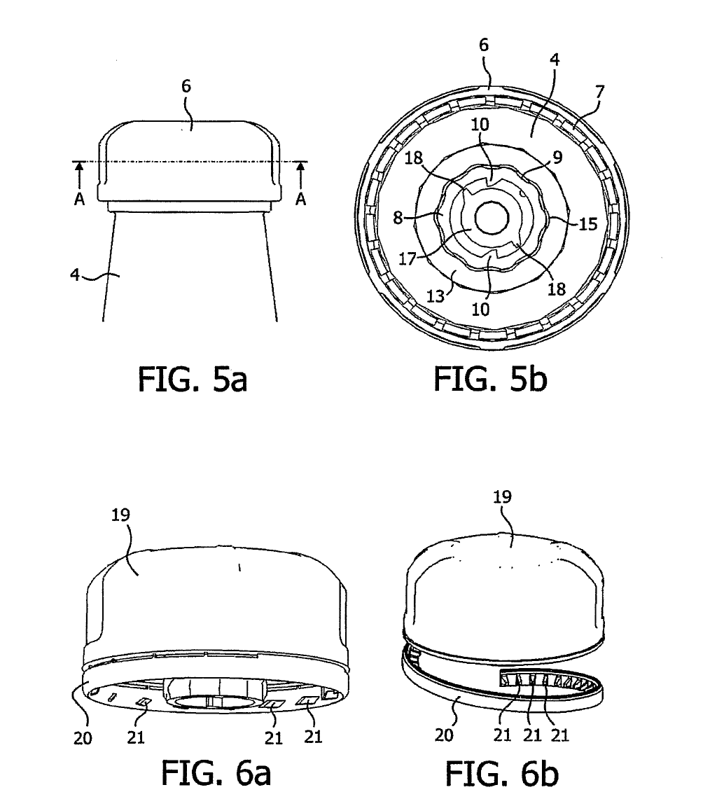

FIG. 5a is a side view of a part of the assembly according to FIGS. 1a-1c,

FIG. 5b shows a cross-section along line A-A of the assembly of the side view of FIG. 5a,

FIGS. 6a and 6b show different perspective views of an alternative securing element for use in a closure according to the invention,

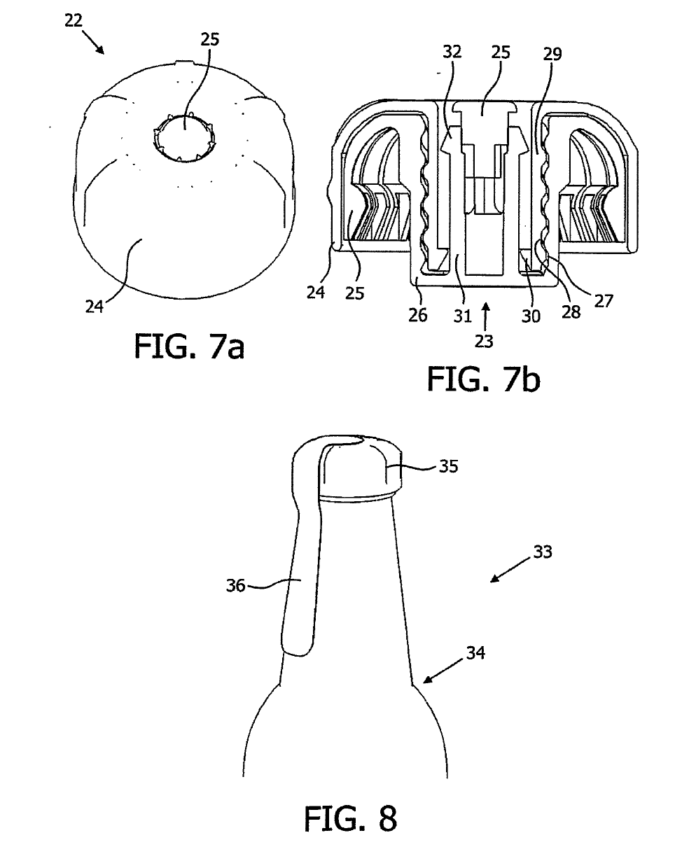

FIG. 7a is a perspective view of another closure according to the invention,

FIG. 7b shows a cross-section of the closure of FIG. 7a,

FIG. 8 shows an assembly of a bottle and yet another closure according to the invention,

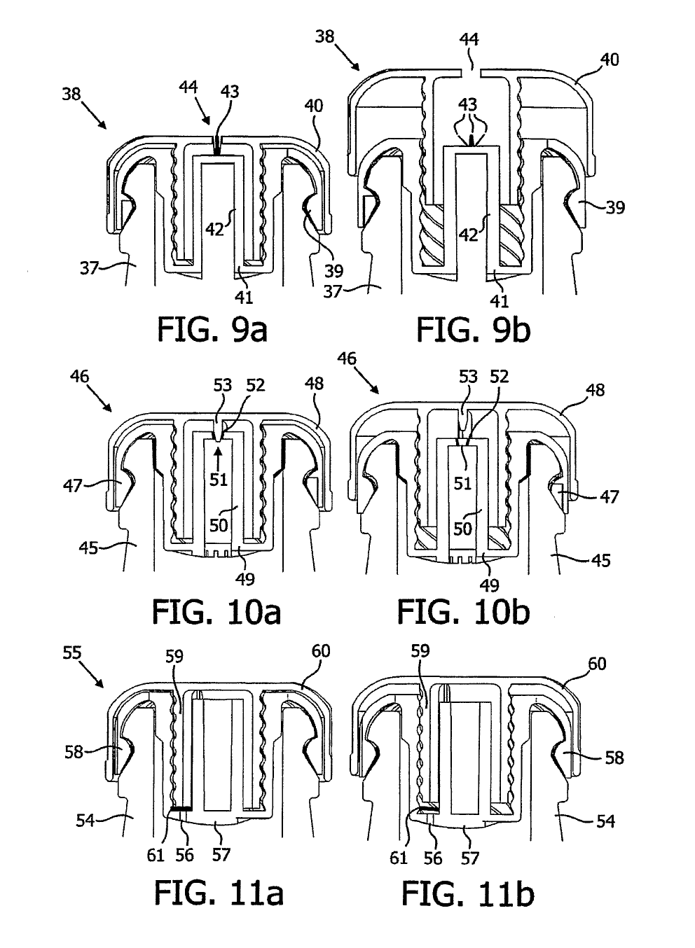

FIGS. 9a and 9b show different longitudinal sections of a closure according to the invention arranged on a neck of a bottle,

FIGS. 10a and 10b show different longitudinal sections of another closure according to the invention arranged on a neck of a bottle,

FIGS. 11a and 11b show different longitudinal sections of yet another closure according to the invention arranged on a neck of a bottle,

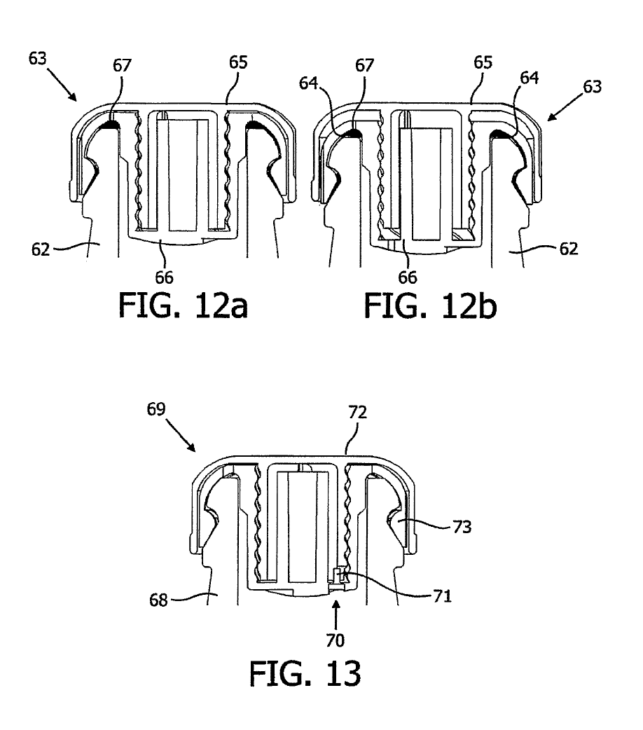

FIGS. 12a and 12b show different longitudinal sections of another closure according to the invention arranged on a neck of a bottle,

FIG. 13 shows a longitudinal section of an alternative closure according to the invention arranged on a neck of a bottle,

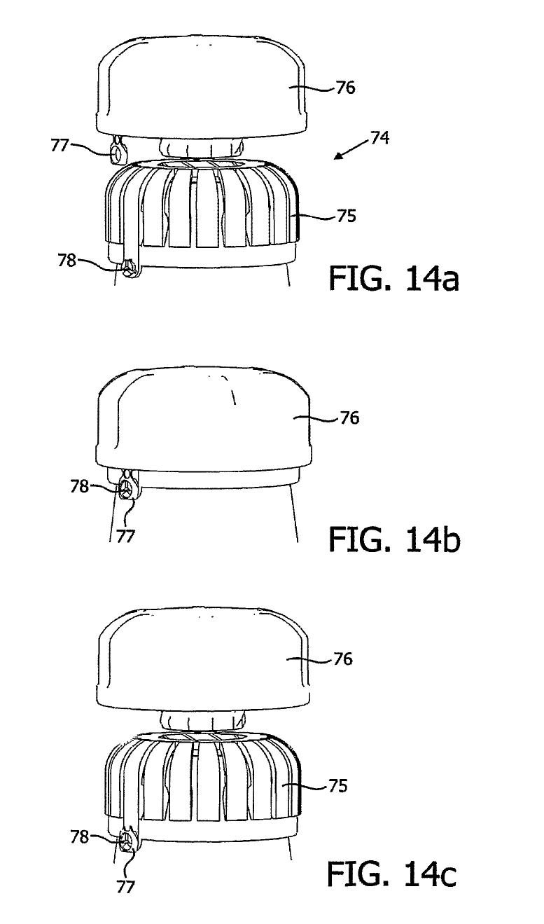

FIGS. 14a-14c show different side views of a closure according to the invention,

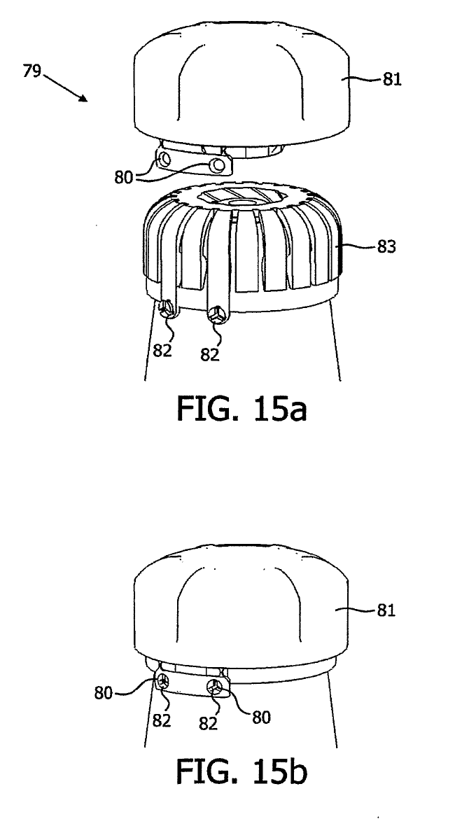

FIGS. 15a and 15b show different perspective views of another closure according to the invention,

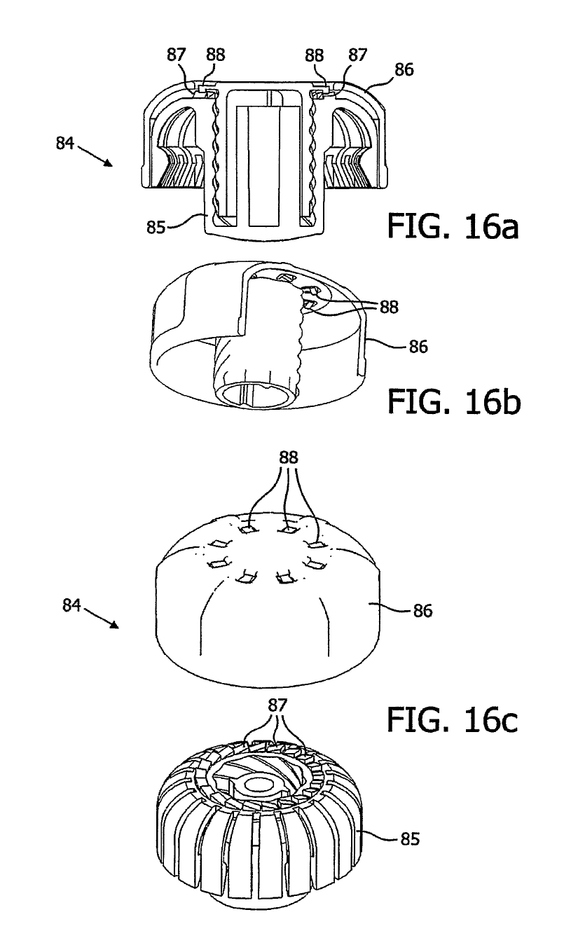

FIGS. 16a-16c show different exploded views of yet another closure according to the invention,

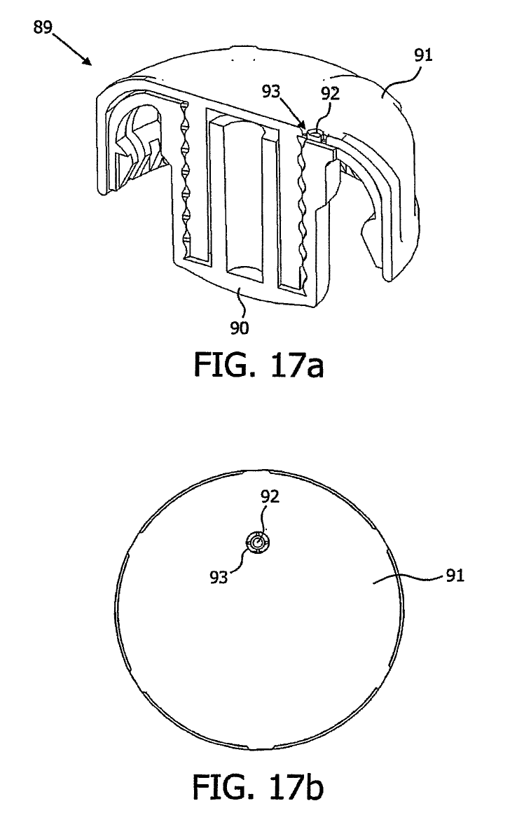

FIG. 17a is a perspective longitudinal section of yet another closure according to the invention,

FIG. 17b is a top view of the closure of FIG. 17a,

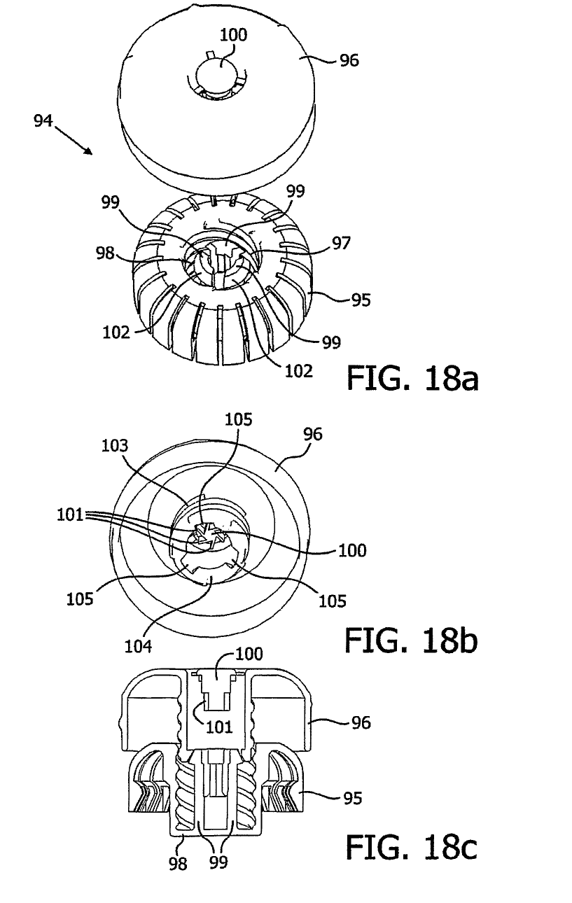

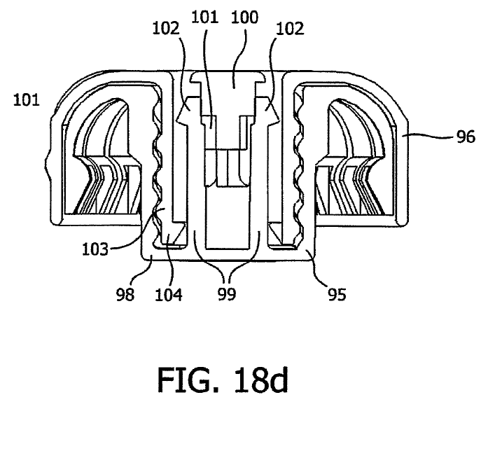

FIG. 18a is an exploded view of an alternative closure according to the invention,

FIG. 18b is a perspective view of a securing element of the closure of FIG. 18a,

FIGS. 18c and 18d show different longitudinal sections of the closure of FIG. 18a, and

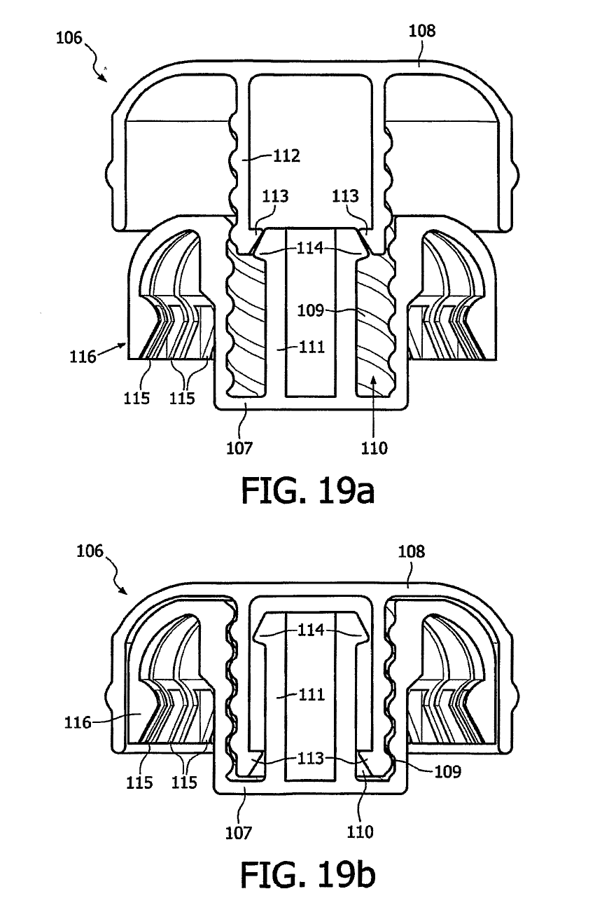

FIGS. 19a and 19b show different longitudinal sections of another closure according to the invention.

FIGS. 1a-1c show side views of an assembly 1 of a bottle 2 and a closure 3 according to the invention. FIG. 1a in particular here shows assembly 1 in an assembled state, wherein closure 3 is arranged on a neck 4 of bottle 2, whereby bottle 2 is closed substantially medium-tightly. Closure 3 comprises a closing element 5 and a securing element 6 connected rotatably to closing element 5. In order to open bottle 2 the securing element 6 is rotated relative to closing element 5 (FIG. 1b), wherein the orientation of closing element 5 relative to neck 4 remains unchanged. Securing element 6 will be displaced in upward direction by rotating securing element 6 relative to closing element 5, whereby clamping elements 7 forming part of closing element 5 come to lie substantially unobstructed. Because clamping elements 7 are no longer locked by securing element 6, closure 3 can be removed from bottle 2 as shown in FIG. 1c.

FIGS. 2a and 2b show different views of securing element 6 for use in closure 3 according to FIGS. 1a-1c. FIG. 2a herein shows a perspective bottom view of securing element 6 and FIG. 2b shows a side view of securing element 6. Shown here is that securing element 6 is provided with a profiling 7 which provides a consumer with an improved grip during axial rotation of securing element 6 relative to closing element 5. Also shown is that securing element 6 comprises a bush-like body 8 provided with an external screw thread 9. An inner side of the bush-like body 8 is provided with two protrusions 10 for limiting the maximum rotation of securing element 6 relative to closing element 5.

FIG. 3 shows a perspective view of closing element 5 for use in closure 1 according to FIGS. 1a-1c. This figure shows clearly that closing element 5 is provided with a plurality of clamping elements 7, wherein each clamping element 7 is provided with an inward protruding clamping tongue 11. The assembly of clamping elements 7 here in fact forms a clamping skirt for engaging round neck 4 of the bottle. The protruding clamping tongues 11 are adapted to engage on a narrowed portion 12 (see FIGS. 4a-4c) arranged in neck 4 of the bottle. Closing element 5 is provided with a tubular element 13 adapted to receive the bush-like body 8 of securing element 6, as shown clearly in FIGS. 4a-4c. Tubular element 13 is provided on an underside with strengthening ribs 14.

FIGS. 4a-4c show different longitudinal sections of a part of assembly 1 according to the respective FIGS. 1a-1c. FIG. 4a herein shows a longitudinal section of closure 3 in a secured position closing neck 4 of a bottle. It can be seen here that clamping tongues 11 of clamping elements 7 engage in narrowed portion 12 of neck 4, whereby closure 3 clamps fixedly on neck 4 of the bottle. This fixed clamping is locked in that securing element 6 prevents clamping elements 7 deforming in the direction away from neck 4, whereby closure 3 would be uncoupled from neck 4 of the bottle. Tubular element 13 is provided with an internal screw thread 15 which co-acts with external screw thread 9 of securing element 6 for the purpose of forming a threaded connection. In the shown secured position both the internal screw thread 15 of closing member 5 and external screw thread 9 of securing element 6 are positioned substantially in neck 4 of the bottle, whereby closure 3 according to the invention is relatively compact, and therefore easy to use and aesthetically attractive. An upper part of tubular element 13 connects via a sealing ring 16 to an inner side of neck 4, whereby bottle 2 can be closed medium-tightly. Tubular element 13 is provided with a standing blocking element 17 which is adapted for co-action with protrusions 10 of securing element 6 for the purpose of bounding the maximum rotation of securing element 6 relative to closing element 5. FIG. 4b shows that securing element 6 is rotated relative to closing element 5, whereby securing element 6 has in fact displaced in a linear upward movement relative to closing element 5. In this shown released position clamping elements 7 are no longer locked by a peripheral part of securing element 6 which in fact functions as a locking skirt. By subsequently pulling securing element 6 in a direction away from neck 4 of the bottle, clamping elements 7 will deform in forced manner in outward direction and closure 3 can be uncoupled from neck 4 as shown in FIG. 4c. Reclosing takes place in reverse sequence, wherein first of all closure 3 is arranged on neck 4 of the bottle, after which closure 3 is fixed relative to neck 4 by rotating securing element 6 relative to closing element 5 until the secured position as shown in FIG. 4a is once again reached.

FIG. 5a shows a side view of a part of assembly 1 of FIGS. 1a-1c in the secured position. FIG. 5b shows a cross-section along line A-A of the view of assembly 1 of FIG. 5a, wherein shown successively from the outside to the inside are securing element 6, clamping elements 7, neck 4, tubular element 13 provided with internal screw thread 15, the bush-like body 8 provided with external screw thread 9 and protrusions 10, and blocking element 17. Also shown is that blocking element 17 is provided with counter-protrusions 18 adapted for co-action with protrusions 10 of the bush-like body 8 to enable limiting of the maximum angle of rotation of securing element 6 relative to closing element 5.

FIGS. 6a and 6b show different perspective views of an alternative securing element 19 for use in a closure according to the invention. Securing element 19 shown in FIG. 6a is structurally identical to securing element 6 shown in FIGS. 1a-5b, with the difference that the securing element 19 shown here is provided with a sealing ring 20 which is initially connected in weakened manner to securing element 19. Sealing ring 20 is provided with teeth 21 which are positioned in the same direction relative to each other, this direction being such that securing element 19 can only be displaced in a clockwise direction without sealing ring 20 breaking. At the first use of the closure the securing element 19 will be rotated in a counter-clockwise direction relative to a closing element (not shown) of the closure for the purpose of displacing the securing element from a secured position to a released position, whereby teeth 21 force sealing ring 20 to break and it will be visible to a consumer that closure 3 has been released at least once.

FIG. 7a shows a perspective view of another closure 22 according to the invention. Closure 22 comprises a closing element 23 (see FIG. 7b) and a securing element 24 connected to closing element 23. Securing element 24 is provided with a sealing pin 25 which is connected in weakened manner to securing element 24. FIG. 7b shows a cross-section of closure 22 of FIG. 7a in which both securing element 24 and closing element 23 are shown. Closing element 23 is structurally similar to the closing element 5 shown in FIGS. 1-5a, wherein closing element 23 is provided with a plurality of clamping elements 25. Closing element 23 moreover comprises a central tubular element 26 provided with an internal screw thread 27. Tubular element 26 is adapted to receive a bush-like body 29 of securing element 24 provided with an external screw thread 28. The bush-like body 29 is moreover provided with internal protrusions 30. Tubular element 26 is provided with a standing blocking element 31 provided with external protrusions 32, wherein the external protrusions 32 of blocking element 31 are adapted for co-action with internal protrusions 30 of bush-like body 29 for the purpose of limiting the maximum rotation of securing element 24 relative to closing element 23. Blocking element 31 is furthermore adapted to fixedly hold sealing pin 25. At a first rotation of securing element 24 relative to closing element 23 sealing pin 25 will break off from securing element 24, whereby it is visible to a consumer that closure 23 has already been released at least once.

FIG. 8 shows an assembly 33 of a bottle 34 and yet another closure 35 according to the invention. Closure 35 is structurally identical to the closure 3 shown in FIGS. 1a-5b. In the present exemplary embodiment the orientation of closure 35 relative to bottle 34 is sealed by means of a strip 36 manufactured from paper, whereby it is immediately visible whether the content of bottle 34 can be guaranteed.

FIGS. 9a and 9b show different longitudinal sections of a closure 38 according to the invention arranged on a neck 37 of a bottle. Closure 38 comprises a closing element 39 and a securing element 40 connected to closing element 39 by means of a threaded connection. Closing element 39 comprises a tubular element 41 provided with a standing central part 42 on which a plurality of sealing biasing members 43 are arranged. In an initial secured position as shown in FIG. 9a the biasing members 43 are partially received in a biased state in a recess 44 arranged in securing element 40. At a first release of closure 38 the securing element 40 will be rotated relative to closing element 39, whereby biasing members 43 will be released (see FIG. 9b). However, when closure 38 is secured again biasing members 43 will no longer be received in recess 44 of securing element 40, whereby a consumer will see relatively quickly and easily that closure 38 has already been released at least once.

FIGS. 10a and 10b show different longitudinal sections of another closure 46 according to the invention arranged on a neck 45 of a bottle. Closure 46 comprises a closing element 47 and a securing element 48 connected to closing element 47 by means of a threaded connection. Closing element 47 comprises a tubular element 49 provided with a standing central part 50. Specific to this exemplary embodiment is that closing element 47 is provided with a ventilation opening 51. Ventilation opening 51 is lined with a sealing ring 52. In the secured position according to FIG. 10a ventilation opening 51 is closed by a pin 53 forming part of securing element 48. Pin 53 will be removed from ventilation opening 51 by rotating securing element 48 relative to closing element 47 from the secured position to the released position (see FIG. 10b), whereby pressure equalization will take place between the pressure prevailing in the bottle and the pressure prevailing outside the bottle, which can considerably facilitate removal of closure 46 from neck 45 of the bottle. Pressure equalization is particularly advantageous when the bottle is filled with a carbonated drink, whereby an overpressure is created in the bottle. Pressure equalization can also be advantageous when an underpressure prevails in the bottle.

FIGS. 11a and 11b show different longitudinal sections of yet another closure 55 according to the invention arranged on a neck 54 of a bottle. Closure 55 is structurally similar to the closure 55 shown in FIGS. 10a and 10b although a ventilation opening 56 is provided on a bottom part of a tubular element 57 of a closing element 58 of closure 55. Ventilation opening 56 can be closed by positioning a bush-like body 59 of a securing element 60 of closure 55 in a secured position of closure 55 (see FIG. 11a). In order to enable optimizing of the sealing of ventilation opening 56, a sealing strip 61 is arranged in tubular element 57. Ventilation opening 56 can be opened by rotating securing element 60 (slightly) relative to closing element 58, whereby venting of the bottle is made possible (see FIG. 11b). FIG. 11b also shows that sealing strip 61 is received displaceably in tubular element 57 in order to enable venting.

FIGS. 12a and 12h show different longitudinal sections of another closure 63 according to the invention arranged on a neck 62 of a bottle. As shown in FIGS. 12a and 12b, closure 63 is also provided with a ventilation opening 64, wherein ventilation opening 64 is formed by a gap between closure 63 and neck 62 of the bottle. The operation of closure 63 is identical to the operation of closure 3 shown in FIGS. 1a-5b. By rotating a securing element 65 of closure 63 from the secured position (see FIG. 12a) relative to a closing element 66 of closure 63 the gap can be created by overpressure in the bottle, whereby pressure equalization can be realized. In order to allow substantially medium-tight connection of closure 63 onto neck 62 of the bottle in the secured position, a sealing ring 67 is positioned as shown in FIG. 12a between closing element 66 and neck 62 of the bottle, which sealing ring 67 is adhered in this exemplary embodiment to closing element 66.

FIG. 13 shows a longitudinal section of an alternative closure 69 according to the invention arranged on a neck 68 of a bottle. Closure 69 according to FIG. 13 is also provided with a ventilation opening 70 which in this exemplary embodiment is initially closed by a breakable pin 71. By rotating securing element 72 of closure 69 relative to a closing element 73 of closure 69 connected to securing element 72 the securing element will cause the pin 71 to break, after which ventilation is made possible between an atmosphere prevailing in the bottle and an atmosphere prevailing outside the bottle. After creation of ventilation opening 70 by breaking off pin 71, ventilation opening 70 cannot be reclosed. In this exemplary embodiment the creation of ventilation opening 70 will therefore be permanent.

FIGS. 14a-14c show different side views of a closure 74 according to the invention. FIG. 14a more particularly shows an exploded view of the closure, in which is shown that closure 74 comprises a closing element 75 and a securing element 76. Securing element 76 is herein provided with an eye 77 and closing element 75 is provided with a bulge 78 which, prior to first use, can be snapped fixedly into eye 77 as shown in FIG. 14b. By then displacing securing element 76 relative to closing element 75 the eye 77 will break off from securing element 76 (see FIG. 14c), whereby it will be visible to a consumer that closure 74 is no longer sealed.

FIGS. 15a and 15b show different perspective views of a similar closure 79 according to the invention. Closure 79 comprises a securing element 81 provided with a plurality of eyes 80 and a closing element 83 provided with a plurality of bulges 82, which bulges can be snapped fixedly into eyes 80 of securing element 81 (see FIG. 15b). By then displacing securing element 81 relative to closing element 83 the eyes 80 will break off from securing element 81, whereby it is visible to the consumer that closure 79 is no longer sealed. The tamper-evident provision of closure 79 shown in FIGS. 15a and 15b is deemed to be structurally somewhat stronger than the shown tamper-evident provision of closure 74 shown in FIGS. 14a and 14b.

FIGS. 16a-16c show different exploded views of yet another closure 84 according to the invention. Closure 84 comprises a closing element 85 and a securing element 86 co-acting with closing element 85. An upper side of closing element 85 is provided with a plurality of protrusions 87. An underside of securing element 86 is provided with a plurality of counter-protrusions 88 (see also FIG. 16b) adapted for co-action with protrusions 87 of closing element 85. Counter-protrusions 88 are visible to a consumer. At a first use the securing element will be rotated relative to closing element 85, whereby protrusions 87 will visibly deform counter-protrusions 88, whereby a consumer can see relatively quickly and easily that closure 84 is no longer sealed.

FIG. 17a shows a perspective longitudinal section of yet another closure 89 according to the invention, and FIG. 17b shows a top view of closure 89. Closure 89 comprises a closing element 90 and a securing element 91 connected to closing element 90 by means of a threaded connection. Securing element 91 is here provided with a pin 92 which is connected in weakened manner to securing element 91. A free (lower) end of pin 92 is received in a receiving space 93 arranged in closing element 90. By rotating securing element 91 and closing element 94 relative to each other the pin 92 will be broken off securing element 90, this being both audible and visible to a consumer, whereby a consumer can determine relatively easily whether or not closure 89 is provided with a seal.

FIG. 18a shows an exploded view of an alternative closure 94 according to the invention. Closure 94 comprises a closing element 95 and a securing element 96. Closing element 95 comprises a tubular element 98 provided with an internal screw thread 97, this tubular element 98 also being provided with a plurality of standing fingers 99. Securing element 96 is provided with a pin 100 protruding in the direction of closing element 95, this pin 100 being welded or adhered to securing element 96. As shown in FIG. 18b, an underside of pin 100 is provided with a plurality of protrusions 101, these protrusions 101 being adapted for co-action with fingers 99 of closing element 95. Protrusions 101 are oriented such that rotation of securing element 96 relative to closing element 95 in a clockwise direction is possible and ensures that protrusions 101 of securing element 96 will engage on fingers 99, whereby pin 100 will break off. This breaking of the seal will be visible to a consumer. Fingers 99 are somewhat flexible and provided on a free (upper) end with an outward protruding edge 102. Securing element 96 comprises a bush-like body 103 for receiving fingers 99. The bush-like body 103 is herein provided with a flange-like edge 104 provided with three recesses 105 for passage of fingers 99. During assembly of closure 94 (see FIG. 18c) fingers 99 will, due to deformation of fingers 99, be snapped into the bush-like body via recesses 105, whereby closing element 95 and securing element 96 are connected non-releasably to each other (see also FIG. 18d).

FIGS. 19a and 19b show different longitudinal sections of another closure 106 according to the invention. FIG. 19a more particularly shows closure 106 in non-assembled situation and FIG. 19b shows the same closure 106 in assembled, secured situation. Closure 106 comprises a closing element 107 and a securing element 108 permanently co-acting with the closing element. Closing element 107 comprises a tubular element 110 provided with an internal screw thread 109, this tubular element 110 also being provided with a standing bush 111. Securing element 108 is provided with a pin 112 protruding in the direction of closing element 107, this pin 112 forming an integral part of securing element 108. As shown, an underside of pin 112 is provided with an inward protruding flange 113 and a top side of bush 111 is provided with an outward protruding flange 114. Because both flanges 113, 114 are adapted for mutual co-action, wherein both flanges 113, 114 in fact form a stop for each other, a snap connection is realized, using which the maximum axial displacement of securing element 108 relative to closing element 107 is bounded. The snap connection will be realized by pressing securing element 108 onto closing element 107, whereby a permanent coupling will be realized between closing element 107 and securing element 108. Unintentional uncoupling of securing element 108 relative to closing element 107 can in this way be prevented. During realizing of the snap connection at least one of the flanges 113, 114 will be at least partially deformed to enable the final permanent connection to be realized. For this purpose at least one flange 113, 114 can be manufactured from a (somewhat) flexible material. It is however also possible to envisage bush 111 for instance being formed by a plurality of pivotable bush segments and/or pin 112 being formed by a plurality of pivotable pin segments in order to allow the snap connections to be more readily realized (with reduced effort). FIGS. 19a and 19b also show that closing element 107 comprises a skirt 116 formed by curved clamping fingers 115 for the purpose of enabling substantially form-fitting engagement round a neck of a bottle. The advantage of this form-fitting engagement round the neck of a bottle by the curved clamping fingers 115 is that a relatively strong, durable and therefore reliable sealing of the bottle can be realized, wherein the risk of (material) creep can be minimized. FIG. 19b also shows that securing element 108 connects substantially form-fittingly onto skirt 116 of closing element 107 in order to enable optimizing of the securing of the closure of the neck of the bottle by closing element 107.

It will be apparent that the invention is not limited to the exemplary embodiments shown and described here, but that within the scope of the appended claims numerous variants are possible which will be self-evident to the skilled person in this field.

1-33. (canceled)

34. A closure for a bottle, comprising:
a closing element provided with a number of clamping elements adapted to engage on a neck of a bottle, this closing element also being provided with coupling means, and
a securing element connected to the closing element and provided with locking means for the clamping elements, this securing element also being provided with counter-coupling means adapted for co-action with the coupling means for the purpose of connecting the closing element to the securing element,
wherein the coupling means and counter-coupling means are adapted to be substantially received in the neck of the bottle, and wherein the coupling means and counter-coupling means are adapted to limit the relative displacement of the securing element relative to the closing element, and wherein the orientation between the closing element and the securing element can be changed between a released position, in which the locking means leave the clamping means substantially unobstructed, and a secured position, in which the locking means substantially fix the clamping means.

35. The closure as claimed in claim 34, wherein the securing element is connected rotatably to the closing element.

36. The closure as claimed in claim 34, wherein the coupling means and the counter-coupling means form a threaded connection.

37. The closure as claimed in claim 34, wherein the securing element is displaceable with a substantially linear movement relative to the closing element.

38. The closure as claimed in claim 34, wherein the closing element comprises a tubular element provided with the coupling means, this tubular element being adapted to receive a part of the securing element provided with the counter-coupling means.

39. The closure as claimed in claim 38, wherein an inward directed side of the tubular element is provided with the coupling means.

40. The closure as claimed in claim 38, wherein the tubular element is adapted to be at least partially received in the neck of the bottle.

41. The closure as claimed in claim 34, wherein the securing element comprises a bush-like body provided with the counter-coupling means.

42. The closure as claimed in claim 38, wherein the tubular element is adapted to receive at least a part of the bush-like body.

43. The closure as claimed in claim 41, wherein an outward directed side of the bush-like body is provided with the counter-coupling means.

44. The closure as claimed in claim 42, wherein the bush-like body is adapted to receive at least one standing blocking element connected to the tubular element, which blocking element is provided with at least one first protrusion for bounding the relative movement of the securing element relative to the closing element.

45. The closure as claimed in claim 44, wherein the bush-like body is provided with at least one second protrusion, wherein the first protrusion forms a stop for the second protrusion.

46. The closure as claimed in claim 34, wherein the closing element comprises at least one ventilation opening.

47. The closure as claimed in claim 46, wherein the securing element is adapted to close the ventilation opening in the secured position of the closure.

48. The closure as claimed in claim 34, wherein the closure comprises a breakable seal connected to the closing element and/or the securing element.

49. The closure as claimed in claim 34, wherein the closure comprises sealing means enabling substantially medium-tight closure of the bottle.

50. The closure as claimed in claim 49, wherein at least a part of the sealing means is adapted to engage on an inner side of the neck of the bottle.

51. The closure as claimed in claim 34, wherein the locking means are positioned at a distance from the clamping means in the released position.

52. The closure as claimed in claim 34, wherein the clamping elements are released and/or secured relative to the neck of a bottle by deformation of at least one clamping element.

53. The closure as claimed in claim 34, wherein the clamping elements comprise resilient clamping tongues arranged substantially in the peripheral direction of the closing element.

54. The closure as claimed in claim 53, wherein the clamping elements are formed by a segmented skirt connected to the closing element.

55. The closure as claimed in claim 34, wherein the clamping elements are provided with a protrusion adapted to engage on a peripheral recess of the neck of a bottle.

56. The closure as claimed in claim 34, wherein the closing element and the securing element are connected non-releasably to each other.

57. The closure as claimed in claim 34, wherein the closing element and/or the securing element are provided with at least one gripping member for a user.

58. The closure as claimed in claim 34, wherein it is manufactured at least partially from at least one material chosen from the group of metals, metal alloys and plastics.

59. A bottle having a closure as claimed in claim 34 connected to the bottle, wherein at least the coupling means are positioned substantially in a neck forming part of the bottle.

60. The bottle of claim 59, wherein the counter-coupling means are positioned substantially in the neck of the bottle in a secured position.

61. The bottle of claim 59, wherein the counter-coupling means are positioned at least partially outside the neck of the bottle in the released position.

62. The bottle of claim 59, wherein the clamping elements engaged on a peripheral side of the neck of the bottle.

63. A method for assembling a bottle and closure as claimed in claim 59, comprising the steps of:
a) filling the bottle with a product, in particular a drink,
b) arranging the closing element on a neck forming part of the bottle, and
c) connecting the securing element to the closing element.

64. The method as claimed in claim 63, wherein step c) is performed before step b).
